(19) United States
(12) Patent Application Publication
(10) Pub. No.: US 2024/0072959 A1
(43) Pub. Date: Feb. 29, 2024

(54) SYSTEMS AND METHODS FOR REQUESTING REFERENCE SIGNALS

(71) Applicant: ZTE CORPORATION, Shenzhen (CN)

(72) Inventors: Guozeng ZHENG, Shenzhen (CN); Chuangxin JIANG, Shenzhen (CN); Bo GAO, Shenzhen (CN); Hao WU, Shenzhen (CN); Zhaohua LU, Shenzhen (CN)

(21) Appl. No.: 18/129,326

(22) Filed: Mar. 31, 2023

Related U.S. Application Data
(63) Continuation of application No. PCT/CN2020/138995, filed on Dec. 24, 2020.

(51) Int. Cl. H04L 5/00; H04W 64/00

(52) U.S. Cl. CPC H04L 5/0048; H04W 64/00

(57) ABSTRACT

A wireless communication method includes sending, by a wireless communication device to a wireless communication node, a message to update a downlink reference signal, wherein the downlink reference signal is configured to position the wireless communication device.

### CROSS-REFERENCE TO RELATED APPLICATION

This application claims the benefit of priority under 35 U.S.C. § 120 as a continuation of International Patent Application No. PCT/CN2020/138995, filed on Dec. 24, 2020, the disclosure of which is incorporated herein by reference in its entirety.

### TECHNICAL FIELD

The disclosure relates generally to wireless communications and, more particularly, to systems and methods for requesting reference signals for positioning.

### BACKGROUND

In current 5G NR, some reference signals only support periodic transmission (e.g., positioning reference signal), which means that the reference signals are always ‘on’ even if there may be no terminals to perform measurement. This design reduces network efficiency in terms of power saving and resource utilization. In addition, some temporary demands are initiated from terminals, which may be unknown to the network side. As such, it is necessary that the terminal can initiate requests to require preferred reference signals. In order to reduce latency and increase robustness, the request signaling can be carried by physical layer channels and other entities.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some arrangements, User Equipment (UE) performs a method including sending, to a Base Station (BS), a message to update a Downlink (DL) Reference Signal (RS), wherein the DL RS is configured to position the UE.

In other arrangements, a BS performs a method including receiving, from a UE, a message to update a DL RS, wherein the DL RS is configured to position the UE.

In other embodiments, a wireless communications apparatus comprising a processor and a memory, wherein the processor is configured to read code from the memory and implement a method including sending, to a BS, a message to update a DL RS, wherein the DL RS is configured to position a UE.

In other embodiments, a computer program product comprising a computer-readable program medium code stored thereupon, the code, when executed by a processor, causing the processor to implement a method including sending, to a BS, a message to update a DL RS, wherein the DL RS is configured to position a UE.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a flowchart of Downlink (DL) Positioning Reference Signal (PRS) transmission procedures in current 5G New Radio (NR) systems, according to various embodiments.

FIG. 2 is a flow chart showing a linkage for trigger states to information, according to various embodiments.

FIG. 3 is a table showing different preamble indices and corresponding request signaling content, according to various embodiments.

FIG. 4 is a table showing different preamble indices with occasion indices and corresponding request signaling content, according to various embodiments.

FIG. 5 is a table showing different preamble indices with specific occasion indices and period indices, according to various embodiments.

FIG. 6A is a flowchart diagram illustrating an example wireless communication method for requesting reference signals, according to various embodiments.

FIG. 6B is a flowchart diagram illustrating an example wireless communication method for requesting reference signals, according to various embodiments.

FIG. 7A illustrates a block diagram of an example base station, according to various embodiments.

FIG. 7B illustrates a block diagram of an example user equipment, according to various embodiments.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

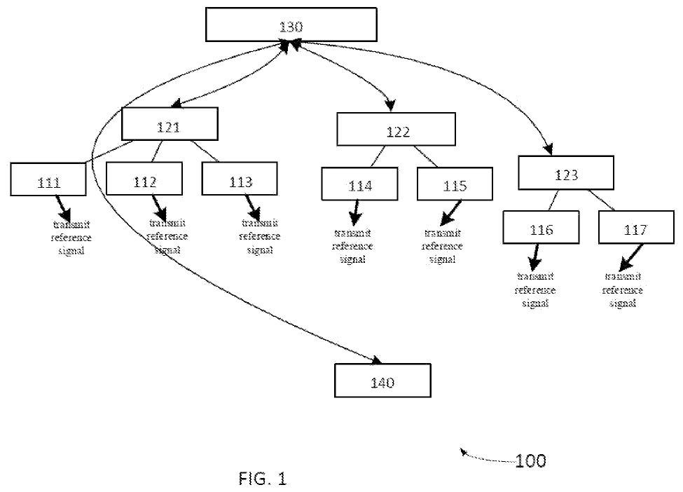

FIG. 1 is a flowchart of DownLink (DL) Positioning Reference Signal (PRS) transmission procedures in current 5G New Radio (NR) systems. First, the DL PRS are configured and transmitted by a plurality of positioning nodes 110 (given in FIG. 1 as 111, 112, 113, 114, 115, 116, and 117). Further, each serving Base Station (BS) (e.g., serving BS 121) or neighboring BS(s) (e.g., first neighboring BS 122 and second neighboring BS 123) may have multiple positioning nodes, where the BS may also be referred to as the NG-RAN node and positioning node may also be referred to as the TRP (Transmission-Reception Point) or TP (Transmission Point) in current 5G New Radio (NR) systems. The serving BS 121 may also be referred to as the serving wireless communication node. The DL PRS configurations are forwarded to a location control entity 130 (e.g., Location Management Function (LMF)) by serving BS 121, the first neighboring BS 122, or the second neighboring BS 123. The DL PRS configurations is then delivered to terminal 140, which is transparent to the serving BS 121. Finally, the User Equipment (UE) receives DL PRS as configured by LMF. The DL PRS only supports periodic transmission in current 5G New Radio (NR) systems.

The DL PRS configurations delivered to terminal are generally one of the following: 1) the LMF will configure one or more positioning frequency layers, which are collections of DL PRS Resource Sets across one or more positioning nodes that have the same Sub-Carrier Spacing (SCS), Cyclic Prefix (CP) type, center frequency, reference frequency, configured BandWidth (BW), and/or comb size. The positioning frequency layer is identified by positioning frequency layer ID; 2) There are some positioning nodes configured under each frequency layer and are identified by positioning node ID information; 3) DL PRS Resource Sets are configured under each positioning node and are identified by DL PRS Resource Set ID; 4) DL PRS Resources are configured within DL PRS Resource Set and are identified by DL PRS Resource ID.

The requesting signals from the terminal can request multiple contents. The terminal is able to request that the transmission of on-going DL PRS be switched ‘off’. The DL PRS may be periodic DL PRS. The requesting signals may further indicate at least one of: (i) one or more positioning frequency layer identifications (IDs); (ii) one or more positioning node IDs; or (iii) one or more downlink positioning reference signal resource set IDs. For example, the positioning node ID=1 and reference signal resource set ID=1 are indicated in the requesting signal, which means the terminal requests the transmission of reference signal resource set ID=1 in positioning node ID=1 to be switched ‘off’.

The terminal can also request pre-configured DL PRS, which means that some of the DL PRS information (e.g. sequence, time-frequency information etc.) has already been configured and buffered in the terminal, such that the terminal is ready to receive the DL PRS once activated or triggered. The request signaling here includes at least one of: 1) when the terminal has been configured with semi-persistent DL PRS but the DL PRS has not been activated (e.g. by MAC CE) or triggered (e.g, by DCI), such that the terminal can initiate request signaling to be activated or triggered by network (e.g. serving base station) to semi-persistently receive DL PRS that has been configured, the request signaling indicates at least one of: (i) one or more trigger state ID(s); (ii) one or more positioning frequency layer identifications (IDs); (iii) one or more positioning node IDs; or (iv) one or more downlink positioning reference signal resource set IDs. For example, the request signaling may indicate a trigger state ID, where some DL PRS may be packaged into the same trigger state that includes/links/indicates at least one of: (i) one or more positioning frequency layer identifications (IDs); (ii) one or more positioning node IDs; or (iii) one or more downlink positioning reference signal resource set IDs. In another example, the request signaling may include one or more positioning node IDs and one or more downlink positioning reference signal resource set IDs. In this example, the positioning frequency layer ID information may be indicated by downlink positioning reference signal resource set ID information implicitly (e.g. downlink positioning reference signal resource set IDs of one positioning node cannot share the same positioning reference signal resource set ID in different positioning frequency layers); 2) when the terminal requests pre-configured semi-persistent DL PRS, the request signaling may also include requested duration of transmitted semi-persistent DL PRS. The requested duration refers to a time span of the semi-persistent DL PRS that is requested to transmit (e.g., from the first transmission of the semi-persistent DL PRS to the last transmission of the semi-persistent DL PRS).

The terminal may be configured with a duration list, with each element on the list corresponding to a specific duration. The terminal may select/indicate at least one of the elements in the request signaling.

When the terminal has been configured with aperiodic DL PRS but the DL PRS has not been triggered, the terminal can initiate request signaling to be activated or triggered by network (e.g. serving base station) to aperiodically receive DL PRS that has been configured. The request signaling indicates at least one of: (i) one or more trigger state ID(s) (ii) one or more positioning frequency layer identifications (IDs); (iii) one or more positioning node IDs; or (iv) one or more downlink positioning reference signal resource set IDs. For example, the request signaling indicates a trigger state ID, where some DL PRS may be packaged into the same trigger state that includes/links/indicates at least one of: (i) one or more positioning frequency layer identifications (IDs); (ii) one or more positioning node IDs; or (iii) one or more downlink positioning reference signal resource set IDs. Another example, the request signaling may include one or more positioning node IDs and one or more downlink positioning reference signal resource set IDs (In this example, the positioning frequency layer ID information may be indicated by downlink positioning reference signal resource set ID information implicitly, e.g. downlink positioning reference signal resource set IDs of one positioning node cannot share the same positioning reference signal resource set ID in different positioning frequency layers);

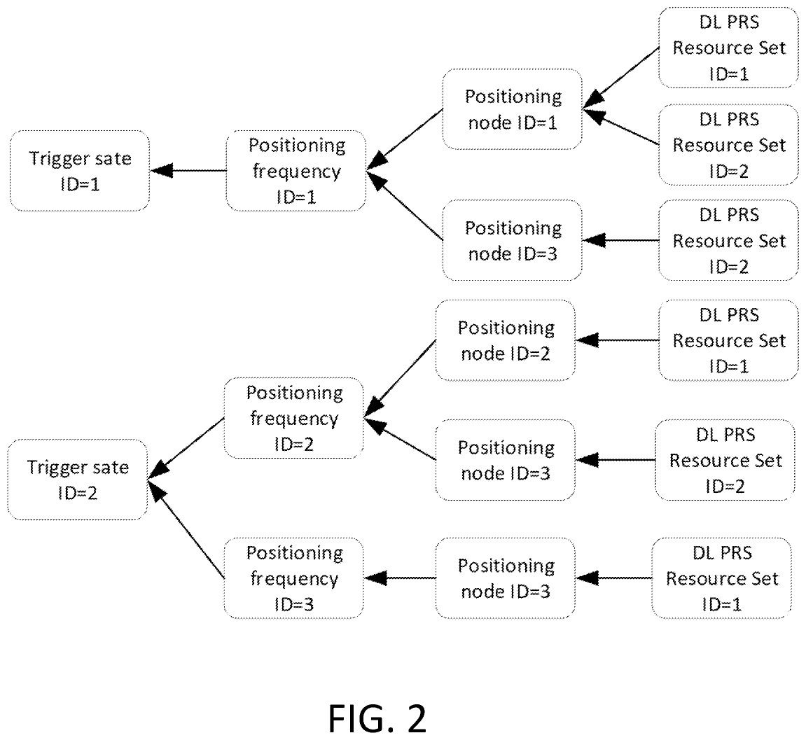

For semi-persistent DL PRS and aperiodic DL PRS, the trigger state ID information can be pre-configured by location control entity, and the location control entity delivers trigger state ID information to BS(s) and terminal separately. Each trigger state includes at least one of: positioning frequency layer ID(s), positioning node ID(s), or DL PRS Resource Set ID(s). FIG. 2 is a flow chart showing a linkage for trigger states to information. As shown in FIG. 2, each DL PRS resource set can be linked to one or more trigger state(s). If one trigger state is requested by terminal, all DL PRS Resource Sets linked to the requested trigger state are also requested.

The terminal can request new DL PRS, for which the request signaling may include at least one of the following: requested resource type (i.e., periodic, semi-persistent, aperiodic DL PRS), requested bandwidth of DL PRS or a general signaling to request high bandwidth of DL PRS, duration of requested DL PRS, periodicity of requested DL PRS, or requested beam. The terminal may be configured with a bandwidth list, with each element in the list corresponding to a specific bandwidth, and the requested bandwidth of DL PRS may be selected/indicated by the terminal from the bandwidth list. The terminal may also be configured with a duration list, with each element in the list corresponding to a specific duration, and the requested duration of DL PRS may be selected/indicated by the terminal from the duration list. The terminal may further be configured with a periodicity list, with each element in the list corresponding to a specific periodicity, and the requested periodicity of DL PRS may be selected/indicated by the terminal from the periodicity list. The terminal may provide a reference signal list of reference signals that has been confirmed to be received with high quality (e.g., the Reference Signal Received Power (RSRP) of all reference signals in the reference signal list are larger than a predefined threshold. As such, the request signaling may include beam-related information (or spatial filter information/beam direction information/beam quality information), where the beam-related information includes at least one of a reference signal and/or the RSRP of the corresponding reference signal. The reference signal can only be selected from pre-configured candidate reference signals. For each positioning node, the terminal may be configured with a candidate reference signal list, on which the candidate reference signals may include DL positioning reference signals and/or Synchronization Signal (SS)/Physical Broadcast Channel (PBCH) blocks. For example, two reference signals from a candidate reference signal list of one positioning node are indicated in the request signaling, which means the terminal requests that the new DL PRS is transmitted/configured/activated/triggered by using similar or the same beam-related information (or spatial filter information/beam direction information/beam quality information).

According to various embodiments, there are different signaling bearers that can carry the contents of the request. In one embodiment utilizing Physical Random Access Channel (PRACH), different preambles may be linked to carry different contents of request signaling. Moreover, a preamble may be linked to carry a specific request signaling only when the preamble is transmitted in certain specific time-frequency resource(s). In one example of this embodiment, there are different time-frequency occasions for the transmission of preamble in a PRACH period, such that a preamble can be linked to carry a specific request signaling only when the preamble is transmitted in certain specific occasion(s). In another example, the preamble can be linked to carry the request signaling only when the preamble is transmitted in certain specific occasion(s) and certain specific period(s), where the period can be the PRACH period or another predefined period. Note that 1) the terminal may be configured with dedicated preamble(s) for the request signaling, [and/or] 2) the predefined period may be configured dedicatedly for the request signaling.

In another embodiment, a general request is carried by Physical Uplink Control Channel (PUCCH) or PRACH, which is followed by a Medium Access Control (MAC) Control Element (CE) with the detailed information. In this embodiment, the network (e.g. serving base station) can define dedicated PUCCH resource(s) or preamble(s) for the request signaling. Once these dedicated PUCCH resource(s) or preamble(s) are transmitted, this means that the terminal requests DL PRS, and the terminal is expected to transmitted MAC CE including detailed information of requested DL PRS. In yet another embodiment, only the MAC CE is used to carry the request signaling, and the MAC CE can be carried by UL-grant Physical Uplink Shared Channel (PUSCH) or configured grant PUSCH. In this embodiment, a dedicated MAC CE subheader should be defined for the purpose of request signaling.

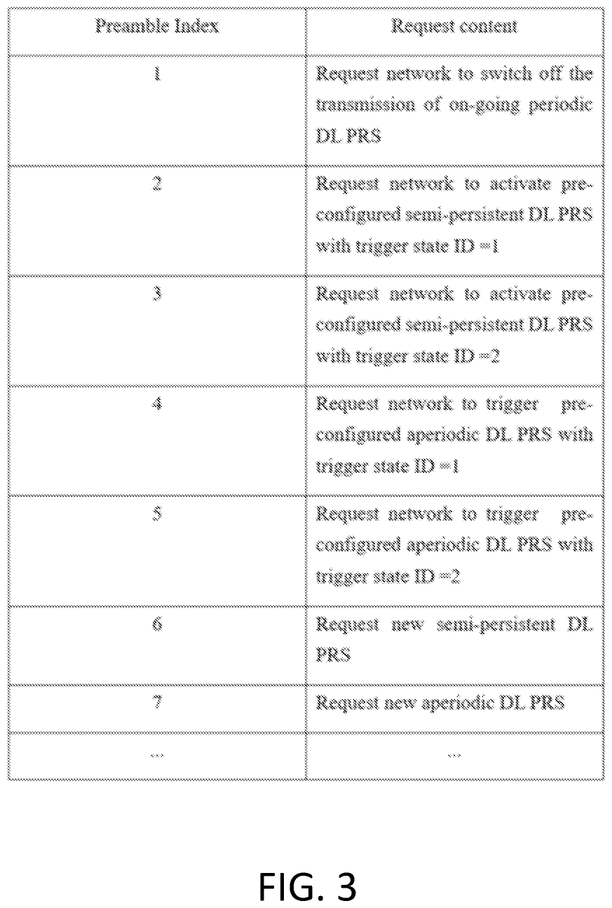

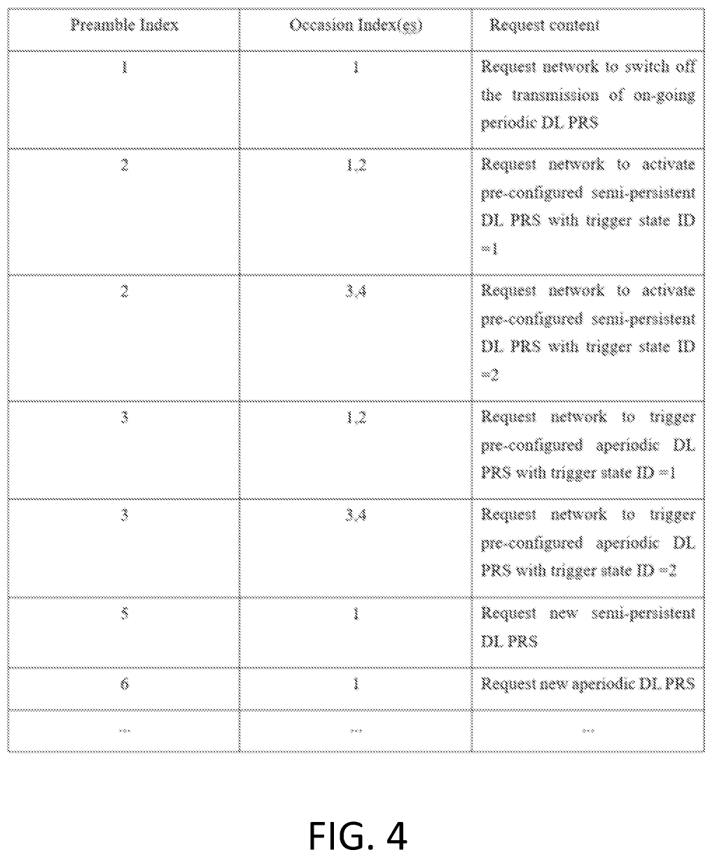

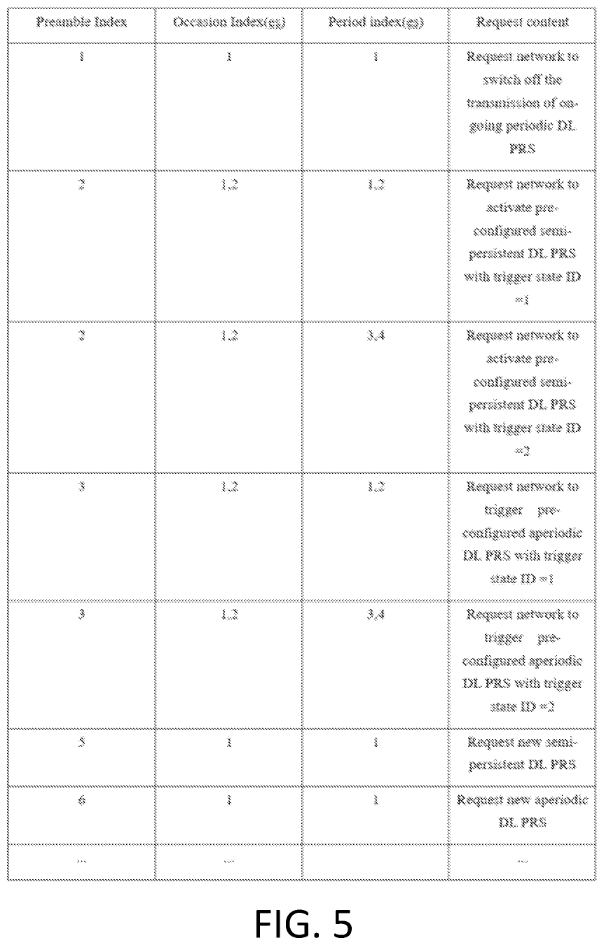

When the requesting signal is borne by PRACH, the preamble may be handled according to various embodiments. In a first embodiment, different preambles are linked to carry different contents of the request signaling. FIG. 3 is a table showing different preamble indices and corresponding request signaling content, according to the first embodiment. In a second embodiment, the preamble can be linked to carry the request signaling only when the preamble is transmitted in certain specific occasions. FIG. 4 is a table showing different preamble indices with occasion indices and corresponding request signaling content, according to the second embodiment. In a third embodiment, the preamble can be linked to carry the request signaling only when the preamble is transmitted in certain occasions and certain specific periods. FIG. 5 is a table showing different preamble indices with specific occasion indices and period indices, and corresponding request signaling content, according to the third embodiment.

When the request signaling is carried by MAC CE, the MAC CE has different fields based on the DL PRS status. In one embodiment in which the request signaling is for pre-configured DL PRS, the MAC CE may have a resource type field, positioning frequency layer field, positioning node field, and a resource set field. The resource type field is to indicate whether semi-persistent DL PRS or aperiodic DL PRS is requested. The positioning frequency layer field is to indicate which positioning frequency layer(s) is requested. The positioning node field is to indicate which positioning node(s) is requested to transmit the DL PRS. The resource set field is to indicate which positioning set(s) is requested.

In a second embodiment in which the request signaling is for a new DL PRS, the MAC CE may have a positioning node list field, a requested bandwidth field, a resource type field, a requested beam information field for the first positioning node indicated in the positioning node list field, and a requested beam information field for the second positioning node indicated in the positioning node list field. The positioning node field is to indicate which positioning node(s) is requested to transmit the DL PRS. The requested bandwidth field is to indicate what bandwidth of DL PRS is requested. The resource type field is to indicate whether periodic DL PRS, semi-persistent DL PRS, or aperiodic DL PRS is requested. The requested beam information field may be used to indicate certain reference signal indices and the corresponding RSRPs for requesting preferred beam information.

In an embodiment for the request signaling bearers discussed herein (i.e., PRACH, PUCCH, MAC CE), after the transmission of the request signaling, the terminal is expected to receive a confirm signaling from BS, where the confirm signaling is to confirm the request signaling is received successfully by BS. The confirm signaling can be carried by a PDCCH scrambled by a specific RNTI in a specific PDCCH search space. The terminal can be predefined or configured for a search time window, where the terminal is expected to receive the confirm signaling in the search time window. If the terminal doesn't receive the confirm signaling in the search time window, the terminal may be expected to repeat the transmission of the request signaling. The total number of repetitions can be predefined or configured. When the requesting signaling is to request that the transmission of on-going DL PRS be switched ‘off’, once the terminal receives the confirm signaling, the terminal is expected to stop receiving the on-going DL PRS indicated in the requesting signaling.

In an embodiment, the request signaling bearers discussed herein (i.e., PRACH, PUCCH, MAC CE, etc.) may only be used to request DL PRS transmitted from positioning nodes served by (or associated with) serving wireless communication node (e.g., the serving BS/serving NG-RAN node/serving MAC entity/serving gNB-CU (Centralized Unit)). In one example, there are multiple positioning nodes (e.g. transmission-reception points/transmission points) controlled/served by the same base station (i.e. serving BS or serving NG-RAN node). In another example, multiple positioning nodes can be the nodes used in Coordinated Multipoint(s) (CoMP) transmission system in Long Term Evolution (LTE) or Multiple-Transmission Reception Points (M-TRP) system in 5G NR (including single-DCI based M-TRP and/or multi-DCI based M-TRP). The different transmission-reception points are differentiated by different coresetPoolIndex in high layer signaling or the number of TransmissionConfigurationIndex (TCI) states in high layer signaling. In some deployment scenarios, the multiple transmission-reception points (i.e. positioning nodes) in M-TRP system of 5G NR can be controlled/served by the same MAC entity (i.e. serving MAC entity). In a further example, each of the positioning nodes is controlled/served by a gNB-Distributed Unit (DU), and all gNB-DUs associated with positioning node are controlled/served by the same gNB-CU (i.e. serving gNB-CU). If new DL PRS is requested by the terminal, the serving BS may configure new DL PRS through Radio Resource Control (RRC) signaling. The serving BS may inform the location control entity about the new DL PRS configuration. There, the location control entity should inform the terminal which positioning nodes are served by the same base station. For example, referring to FIG. 1, the location control entity 130 would indicate that positioning nodes 111-113 are all served by (or associated with) the same serving BS 121.

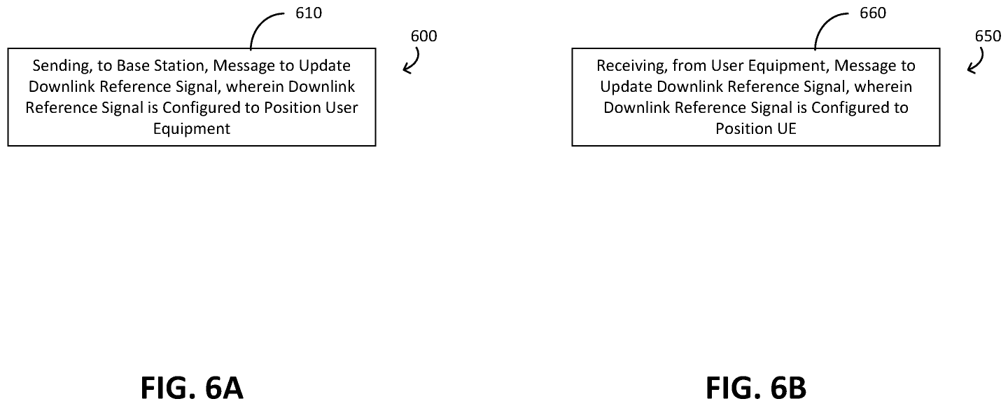

FIG. 6A is a flowchart diagram illustrating an example wireless communication method 600, according to various arrangements. Method 600 can be performed by a UE, and begins at 610 where the UE sends a message to update a DL RS to a BS, and the RS is configured to position the UE (i.e., a PRS). Updating the DL RS can include requesting the BS (or network) to terminate an on-going DL RS, requesting the BS (or network) to send signaling that activates/triggers the UE (or terminal) to receive the RS, or requesting the BS (or network) to configure a new RS (to the UE) that the UE receives according to the new configurations.

In some embodiments, sending the message includes a request to terminate a transmission of an on-going DL RS. In these embodiments, the message may also include at least one of one or more positioning frequency layer IDs, one or more positioning node IDs, or one or more DL PRS resource set IDs.

In other embodiments, sending the message includes a request from the UE to be activated (by MAC CE) or triggered (by DCI) by the BS to receive the configured DL RS semi-persistently or triggered (by DCI) by the BS to receive the configured DL RS aperiodically. In these embodiments, the message indicates which of the plurality of configured durations is selected for receiving the DL RS. The plurality of configured durations may be included in a pre-configured duration list. In other of these embodiments, the message indicates at least a trigger stated ID that includes at least one of one or more positioning frequency layer IDs, one or more positioning node IDs, or one or more DL PRS resource set IDs.

In further embodiments, sending the message includes a request for an expected resource type to receive a DL RS that has not been configured. The expected resource type includes the DL RS to be received periodically, aperiodically, or semi-persistently. In some of these embodiments, the message includes an indication of which of the plurality of configured bandwidths is selected for receiving the DL RS. The plurality of configured bandwidths may be included in a pre-configured bandwidth list. In other of these embodiments, the message indicates which of the plurality of configured durations is selected for receiving the DL RS. The plurality of configured durations may be included in a pre-configured duration list. In yet further embodiments, the message includes a request for beam-related information associated with the BS.

In each of the above-described embodiments, the method 600 may include the UE sending a PRACH message that includes the request (e.g., request to terminate transmission of an on-going DL RS, request to be triggered semi-persistently or aperiodically, request for an expected resource type, etc.). This PRACH message may include a preamble specifically associated with the request. In other of the above-described embodiments, the method 600 may include sending a PRACH message or a PUCCH message indicating the request. In further of the above-described embodiments, the method 600 may include sending a UL grant that includes a MAC CE indicating the request. The UL grant may be a configured grant PUSCH, and the MAC CE may include a sub-header specifically associated with the request. As discussed herein, the PRACH message, PUCCH message, or UL grant may each be specifically configured to request the DL RS that is transmitted by one or more positioning nodes associated with the serving wireless communication node (e.g., the serving BS/serving NG-RAN node/serving gNB-CU).

FIG. 6B is a flowchart diagram illustrating an example wireless communication method 650, according to various arrangements. Method 650 can be performed by a BS, and begins at 660 where the BS receives a message to update a DL RS from a UE, and the RS is configured to position the UE (i.e., a PRS). Updating the DL RS can include requesting the BS (or network) to terminate an on-going DL RS, requesting the BS (or network) to send signaling that activates/triggers the UE (or terminal) to receive the RS, or requesting the BS (or network) to configure a new RS (to the UE) that the UE receives according to the new configurations.

In some embodiments, receiving the message includes receiving a request to terminate a transmission of an on-going DL RS. In these embodiments, the message may also include at least one of one or more positioning frequency layer IDs, one or more positioning node IDs, or one or more DL PRS resource set IDs.

In other embodiments, receiving the message includes receiving a request from the UE to be activated (by MAC CE) or triggered (by DCI) by the BS to receive the configured DL RS semi-persistently or triggered (by DCI) by the BS to receive the configured DL RS aperiodically. In these embodiments, the message indicates which of the plurality of configured durations is selected for receiving the DL RS. The plurality of configured durations may be included in a pre-configured duration list. In other of these embodiments, the message indicates a trigger stated ID that includes at least one of one or more positioning frequency layer IDs, one or more positioning node IDs, or one or more DL PRS resource set IDs.

In further embodiments, receiving the message includes receiving a request for an expected resource type to receive a DL RS that has not been configured. The expected resource type includes the DL RS to be received periodically, aperiodically, or semi-persistently. In some of these embodiments, the message includes an indication of which of the plurality of configured bandwidths is selected for receiving the DL RS. The plurality of configured bandwidths may be included in a pre-configured bandwidth list. In other of these embodiments, the message indicates which of the plurality of configured durations is selected for receiving the DL RS. The plurality of configured durations may be included in a pre-configured duration list. In yet further embodiments, the message includes a request for beam-related information associated with the BS.

In each of the above-described embodiments, the method 650 may include the BS receiving a PRACH message that includes the request (e.g., request to terminate transmission of an on-going DL RS, request to be triggered semi-persistently or aperiodically, request for an expected resource type, etc.). This PRACH message may include a preamble specifically associated with the request. In other of the above-described embodiments, the method 650 may include receiving a PRACH message or a PUCCH message indicating the request. In further of the above-described embodiments, the method 650 may include receiving a UL grant that includes a MAC CE indicating the request. The UL grant may be a configured grant PUSCH, and the MAC CE may include a sub-header specifically associated with the request. As discussed herein, the PRACH message, PUCCH message, or UL grant may each be specifically configured to request the DL RS that is transmitted by one or more positioning nodes associated with the serving wireless communication node (e.g., the serving BS/serving NG-RAN node/serving gNB-CU).

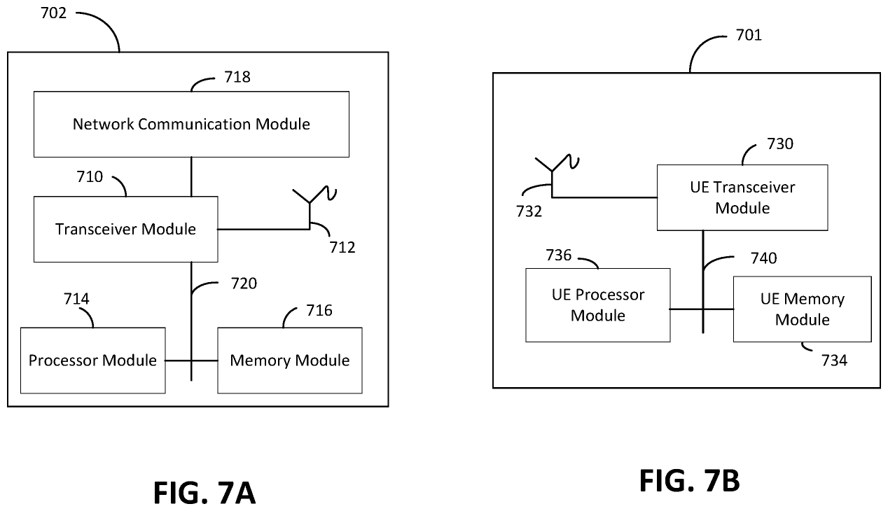

FIG. 7A illustrates a block diagram of an example BS 702, in accordance with some embodiments of the present disclosure. FIG. 7B illustrates a block diagram of an example UE 701, in accordance with some embodiments of the present disclosure. The UE 701 (e.g., a wireless communication device, a terminal, a mobile device, a mobile user, and so on) is an example implementation of the UEs described herein, and the BS 702 is an example implementation of the BS described herein.

The BS 702 and the UE 701 can include components and elements configured to support known or conventional operating features that need not be described in detail herein. In one illustrative embodiment, the BS 702 and the UE 701 can be used to communicate (e.g., transmit and receive) data symbols in a wireless communication environment, as described above. For instance, the BS 702 can be a BS (e.g., gNB, eNB, and so on), a server, a node, or any suitable computing device used to implement various network functions.

The BS 702 includes a transceiver module 710, an antenna 712, a processor module 714, a memory module 716, and a network communication module 718. The module 710, 712, 714, 716, and 718 are operatively coupled to and interconnected with one another via a data communication bus 720. The UE 701 includes a UE transceiver module 730, a UE antenna 732, a UE memory module 734, and a UE processor module 736. The modules 730, 732, 734, and 736 are operatively coupled to and interconnected with one another via a data communication bus 740. The BS 702 communicates with the UE 701 or another BS via a communication channel, which can be any wireless channel or other medium suitable for transmission of data as described herein.

As would be understood by persons of ordinary skill in the art, the BS 702 and the UE 701 can further include any number of modules other than the modules shown in FIGS. 7A and 7B. The various illustrative blocks, modules, circuits, and processing logic described in connection with the embodiments disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The embodiments described herein can be implemented in a suitable manner for each particular application, but any implementation decisions should not be interpreted as limiting the scope of the present disclosure.

In accordance with some embodiments, the UE transceiver 730 includes a radio frequency (RF) transmitter and a RF receiver each including circuitry that is coupled to the antenna 732. A duplex switch (not shown) may alternatively couple the RF transmitter or receiver to the antenna in time duplex fashion. Similarly, in accordance with some embodiments, the transceiver 710 includes an RF transmitter and a RF receiver each having circuitry that is coupled to the antenna 712 or the antenna of another BS. A duplex switch may alternatively couple the RF transmitter or receiver to the antenna 712 in time duplex fashion. The operations of the two-transceiver modules 710 and 730 can be coordinated in time such that the receiver circuitry is coupled to the antenna 732 for reception of transmissions over a wireless transmission link at the same time that the transmitter is coupled to the antenna 712. In some embodiments, there is close time synchronization with a minimal guard time between changes in duplex direction.

The UE transceiver 730 and the transceiver 710 are configured to communicate via the wireless data communication link, and cooperate with a suitably configured RF antenna arrangement 712/732 that can support a particular wireless communication protocol and modulation scheme. In some illustrative embodiments, the UE transceiver 730 and the transceiver 710 are configured to support industry standards such as the Long Term Evolution (LTE) and emerging 5G standards, and the like. It is understood, however, that the present disclosure is not necessarily limited in application to a particular standard and associated protocols. Rather, the UE transceiver 730 and the BS transceiver 710 may be configured to support alternate, or additional, wireless data communication protocols, including future standards or variations thereof.

The transceiver 710 and the transceiver of another BS (such as but not limited to, the transceiver 710) are configured to communicate via a wireless data communication link, and cooperate with a suitably configured RF antenna arrangement that can support a particular wireless communication protocol and modulation scheme. In some illustrative embodiments, the transceiver 710 and the transceiver of another BS are configured to support industry standards such as the LTE and emerging 5G standards, and the like. It is understood, however, that the present disclosure is not necessarily limited in application to a particular standard and associated protocols. Rather, the transceiver 710 and the transceiver of another BS may be configured to support alternate, or additional, wireless data communication protocols, including future standards or variations thereof.

In accordance with various embodiments, the BS 702 may be a BS such as but not limited to, an eNB, a serving eNB, a target eNB, a femto station, or a pico station, for example. The BS 702 can be an RN, a DeNB, or a gNB. In some embodiments, the UE 701 may be embodied in various types of user devices such as a mobile phone, a smart phone, a personal digital assistant (PDA), tablet, laptop computer, wearable computing device, etc. The processor modules 714 and 736 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 714 and 736, respectively, or in any practical combination thereof. The memory modules 716 and 734 may be realized as RAM memory, flash memory, ROM memory, EPROM memory, EEPROM memory, registers, a hard disk, a removable disk, a CD-ROM, or any other form of storage medium known in the art. In this regard, memory modules 716 and 734 may be coupled to the processor modules 714 and 736, respectively, such that the processors modules 714 and 736 can read information from, and write information to, memory modules 716 and 734, respectively. The memory modules 716 and 734 may also be integrated into their respective processor modules 714 and 736. In some embodiments, the memory modules 716 and 734 may each include a cache memory for storing temporary variables or other intermediate information during execution of instructions to be executed by processor modules 714 and 736, respectively. Memory modules 716 and 734 may also each include non-volatile memory for storing instructions to be executed by the processor modules 714 and 736, respectively.

The network communication module 718 generally represents the hardware, software, firmware, processing logic, and/or other components of the BS 702 that enable bi-directional communication between the transceiver 710 and other network components and communication nodes in communication with the BS 702. For example, the network communication module 718 may be configured to support internet or WiMAX traffic. In a deployment, without limitation, the network communication module 718 provides an 502.3 Ethernet interface such that the transceiver 710 can communicate with a conventional Ethernet based computer network. In this manner, the network communication module 718 may include a physical interface for connection to the computer network (e.g., Mobile Switching Center (MSC)). In some embodiments, the network communication module 718 includes a fiber transport connection configured to connect the BS 702 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
sending, by a wireless communication device to a wireless communication node, a message to update a downlink reference signal,
wherein the downlink reference signal is configured to position a user equipment (UE).

2. The wireless communication method of claim 1, wherein sending the message further comprises:
requesting, by the wireless communication device, to terminate a transmission of an on-going downlink reference signal.

3. The method of claim 2, wherein the message further indicates at least one of: (i) one or more positioning frequency layer identifications (IDs); (ii) one or more positioning node IDs; or (iii) one or more downlink positioning reference signal resource set IDs.

4. The wireless communication method of claim 1, wherein sending the message further comprises:
requesting, by the wireless communication device, to be activated or triggered by the wireless communication node to semi-persistently receive the downlink reference signal that has been configured; and
indicating, by the wireless communication device in the message, which duration from a plurality of configured durations is selected for receiving the downlink reference signal.

5. The wireless communication method of claim 4, wherein the message indicates at least a trigger state identification (ID) that further includes at least one of: (i) one or more positioning frequency layer IDs; (ii) one or more positioning node IDs; or (iii) one or more downlink positioning reference signal resource set IDs.

6. The wireless communication method of claim 1, wherein sending the message further comprises:
indicating, by the wireless communication device in the message, which bandwidth from a plurality of configured bandwidths is selected for receiving the downlink reference signal.

7. The wireless communication method of claim 1, wherein sending the message further comprises:
requesting, by the wireless communication device, beam-related information associated with the wireless communication node.

8. A wireless communication device, comprising:
at least one processor configured to:
send, via a transmitter to a wireless communication node, a message to update a downlink reference signal,
wherein the downlink reference signal is configured to position a user equipment (UE).

9. A wireless communication node, comprising:
at least one processor configured to:
receive, via a receiver from a wireless communication device, a message to update a downlink reference signal,
wherein the downlink reference signal is configured to position a user equipment (UE).

10. A wireless communication method, comprising:
receiving, by a wireless communication node from a wireless communication device, a message to update a downlink reference signal,
wherein the downlink reference signal is configured to position a user equipment (UE).

11. The wireless communication method of claim 10, wherein receiving the message further comprises:
receiving a request from the wireless communication device to terminate a transmission of an on-going downlink reference signal.

12. The wireless communication method of claim 11, wherein the message further indicates at least one of: (i) one or more positioning frequency layer identifications (IDs); (ii) one or more positioning node IDs; or (iii) one or more downlink positioning reference signal resource set IDs.

13. The wireless communication method of claim 10, wherein receiving the message further comprises:
receiving a request from the wireless communication device to be activated or triggered by the wireless communication node to semi-persistently receive the downlink reference signal that has been configured; and
receiving an indication in the message, on which duration from a plurality of configured durations is selected for receiving the downlink reference signal.

14. The wireless communication method of claim 13, wherein the message indicates at least a trigger state identification (ID) that further includes at least one of: (i) one or more positioning frequency layer IDs; (ii) one or more positioning node IDs; or (iii) one or more downlink positioning reference signal resource set IDs.

15. The wireless communication method of claim 10, wherein receiving the message further comprises:
receiving a request from the wireless communication device, for beam-related information associated with the wireless communication node.
